(19) United States
(12) Patent Application Publication
(10) Pub. No.: US 2025/0060553 A1
(43) Pub. Date: Feb. 20, 2025

(54) Optical Fiber Guide and Winding Tray Device and Method

(71) Applicants: Xiwen Wang, San Jose, CA (US); Ge Yi, San Jose, CA (US); Zining Huang; Qinrong Yu, San Jose, CA (US); Jiawei Liu, San Jose, CA (US)

(72) Inventors: Xiwen Wang, San Jose, CA (US); Ge Yi, San Jose, CA (US); Zining Huang; Qinrong Yu, San Jose, CA (US); Jiawei Liu, San Jose, CA (US)

(21) Appl. No.: 18/233,795

(22) Filed: Aug. 14, 2023

(51) Int. Cl. G02B 6/44

(52) U.S. Cl. CPC G02B 6/4457

(57) ABSTRACT

An optical cable handling device includes an opto-electronic module with an optical fiber, an optical fiber winding tray to receive the optical fiber, and a guide coupling the module and tray. The guide contains a track to thread the fiber from the module to the tray, wherein the guide comprises a guide bottom surface tangent to the module bottom surface and a guide top surface tangent to the tray bottom surface. This configuration aids in efficiently threading and winding the optical fiber, providing a predetermined bend radius for the fiber during the process. The device also includes a heat sink for heat management. The disclosed method involves securing an optical fiber by providing a winding tray, coupling a guide, and rotating the tray to spool the fiber onto the tray.

### BACKGROUND OF THE INVENTION

Optoelectronics is a branch of technology concerned with the combined application of electronics and light. As the demand for optoelectronic technology grows, so does the need for efficient methods and devices to manage optical fibers that are fundamental to these technologies. Optical fibers carry light signals over long distances with high efficiency, but they can be challenging to manage due to their delicate nature.

Improper management of optical fibers can lead to bending or looping of the fibers, which negatively impacts the transmission of signals and may lead to irreparable damage, reducing the lifespan of the fiber. It is also crucial to properly heat manage opto-electronic modules to prevent overheating and associated complications. Therefore, there is a need for a single, integrated device that manages the optical fiber while also ensuring efficient heat dissipation.

Existing solutions for optical fiber management and heat dissipation are often complex and bulky, leading to difficulties in their implementation and handling. Additionally, they may not adequately prevent bending or looping of the fiber or effectively manage heat, leading to performance degradation. As a result, a more compact, user-friendly and efficient device is needed for managing optical fibers and dissipating heat in opto-electronic systems.

### SUMMARY OF THE INVENTION

In one aspect, an optical system includes an opto-electronic module or silicon photonic module with an optical fiber extend therefrom, an optical fiber winding tray to receive the optical fiber, and a guide coupling the module and tray. The guide contains a track to thread the fiber from the module to the tray, wherein the guide comprises a guide bottom surface tangent to the module bottom surface and a guide top surface tangent to the tray bottom surface.

In another aspect, a method to secure a fiber optic cable includes providing an optical fiber winding tray to receive the optical fiber, the optical fiber winding tray having a tray bottom surface and coupling a guide to the opto-electronic module and the optical fiber winding tray, the guide including a track to thread the optical fiber from the opto-electronic module to the optical fiber winding tray, wherein the guide comprises a guide bottom surface tangent to the module bottom surface and a guide top surface tangent to the tray bottom surface; and rotating the optical fiber winding tray to spool the optical fiber onto the optical fiber winding tray.

In another aspect, a method to secure an optical fiber with a minimum bend radius coupled to an opto-electronic module having a module bottom surface, the method including providing an optical fiber winding tray to receive the optical fiber, the optical fiber winding tray having a footprint smaller than the module bottom surface; coupling a guide to the opto-electronic module and the optical fiber winding tray, the guide extending from the module bottom surface and receiving the optical fiber thereon, wherein the guide provides an optical fiber bending curvature greater than the minimum bend radius; and rotating the optical fiber winding tray to spool the optical fiber on the guide onto the optical fiber winding tray.

Advantages of the above aspects may include one or more of the following. This configuration aids in efficiently threading and winding the optical fiber, providing a predetermined bend radius for the fiber during the process. The device also includes a heat sink for heat management. The design provides a small footprint fiber tray over the optical module which still have all the fiber bending curvature larger than 5 mm so that a low cost 5 mm bending radium fiber can be used without causing fiber damage. The design achieves the all the bending curvature larger than 5 mm while maintaining small footprint. The design can provide a) meet large than 5 mm bending radius in the design for both protection the fiber and also allow to us of low cost fiber with 5 mm bending radius rather than expensive fiber with an even smaller bending radius requirement.

### BRIEF DESCRIPTION OF DRAWINGS

FIG. 1 shows an exemplary illustration of a method to spool optical fibers while preserving optical fiber properties.

FIG. 2 shows an exemplary perspective view of the device to safely spool optical fibers onto a winding tray.

FIGS. 3-4 show side views of the device of FIG. 2.

FIG. 5 shows an exploded view of the device of FIG. 2.

FIGS. 6-7 show in more details the device of FIG. 2.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

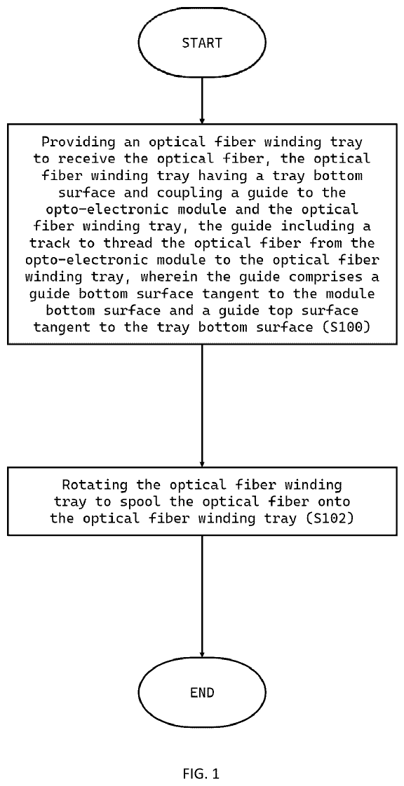

FIG. 1 shows an exemplary illustration of a method to spool optical fibers while preserving optical fiber properties. The method can secure an optical fiber coupled to an opto-electronic/silicon photonic (SiPh) module having a module bottom surface, the method including providing an optical fiber winding tray to receive the optical fiber, the optical fiber winding tray having a tray bottom surface and coupling a guide to the opto-electronic module and the optical fiber winding tray, the guide including a track to thread the optical fiber from the opto-electronic module to the optical fiber winding tray, wherein the guide comprises a guide bottom surface tangent to the module bottom surface and a guide top surface tangent to the tray bottom surface; and rotating the optical fiber winding tray to spool the optical fiber onto the optical fiber winding tray.

The system and method of use are designed and developed to address the critical need of maintaining a predetermined bend radius for optical fibers prior to their mounting on a winding tray. Optical fibers are frequently used in various fields including telecommunications, networking, and data storage, providing critical data links between different components. Unlike traditional copper wires, optical fibers transmit informational data signals in the form of light waves which require a gentle bend to prevent the loss of signal or fiber crack. The precise regularity and control in the bending radius of the optical fibers have proven to significantly affect the operation and lifespan of these fibers. Therefore, a device that can ensure the optical cable is bent at a predetermined radius prior to winding is of great utility and need. The method is optimal in the field of telecommunications, more specifically, to opto-electronic devices. The device includes an opto-electronic module with an optical fiber and a module bottom surface. This module, being the heart of the device, allows for the creation of a robust and efficient communication path utilizing light-based signals, establishing high-speed and reliable data transfer.

An integral part of the device is an optical fiber winding tray that serves as a platform to receive the optical fiber. The tray has a tray bottom surface and is designed to manage the placement and winding of the fiber, increasing the ease of maintenance and ensuring the efficient, structured, and secure layout of the fiber. This helps in avoiding any damage or entanglement that might potentially degrade the signal quality or damage the fiber optic cable.

The fiber core within the cable is constructed from one or more glass fibers that are capable of transmitting light energy along its length. The core is encircled by a tight buffer, aramid yarn and an outer jacket to protect it from environmental elements. Additionally, connectors are used to connect the cables to various devices, such as transmitters and receivers. These connectors enable a secure connection and provide strain relief for the cable.

The device also includes a guide that is coupled to both the opto-electronic module and the optical fiber winding tray. It works as a conduit, routing the optical fiber between the module and the tray, promoting a pathway that mitigates the risk of damage and strengthens the organizational structure of the configuration.

This guide is constructed to thread the optical fiber from the opto-electronic module towards the optical fiber winding tray. The guide's exceptional design forms a track that ensures the safe passage of the optical fiber, reducing the potential for cracks, kinks, or bends that could compromise the integrity of the data transfer.

The guide is designed with a guide bottom surface tangent to the module bottom surface. This specific configuration facilitates a smooth transition of the optical fiber from the module to the guide, reducing the risk of abrupt bends or damage to the fiber. Tangency in one embodiment is a straight line or plane that touches a curve or curved surface at a single point without crossing it. the context of the guide surfaces tangent to the winding tray and electronic module, a tangent would refer to the two surfaces that touch each other without any points of intersection. This allows for the tray and module to fit securely and snugly against one another.

The guide's top surface is similarly designed to be tangent to the tray bottom surface. This aids the smooth transfer of the optical fiber from the guide onto the optical fiber winding tray, thereby maintaining the logical uniformity of the fiber layout and providing a streamlined path, which again reduces any potential damage or loss in transmission quality.

The invention thus achieves a high degree of integration by combining the opto-electronic module, the optical fiber winding tray, and the guide. It provides a simplified structure that is easy to manufacture and maintain, while ensuring superior performance and durability. This novel design optimizes the routing of optical fibers, minimizing potential damages and enhancing the overall efficiency and reliability of opto-electronic communications.

The rotating tray is used for winding fibers onto the tray. The rotating tray can be engaged by a user or activated by an integrated motor, enabling a steady, continuous motion for the winding of fiber. This mechanism serves functionally to organize, conserve, or maintain the structural integrity or uniformity of fibers as needed. The scope of applicable fibers could extend to a broad range including yarn, thread, wire, cable, string, rope, twine, cord, or even narrow plastics.

The rotating tray mechanism is notable for its simplicity and efficiency. Upon rotation, the tray secures the fiber at its initial contact point, and as the rotation progresses, the subsequent fiber length is methodically wound onto the tray in a circular or spiral pattern. The rotatory motion can be adjusted for speed, direction, and degree of rotation to accommodate the desired winding pattern or fiber property. The tray may also include features such as peripheral containment walls, grooves, or fiber-guiding paths to reinforce the orderly winding of the fiber or assist in handling different fiber types or sizes.

Furthermore, the intricate design of this innovative device promotes versatility in facilitating a range of operations involving thermoplastic resins, glass, aramid, carbon-filled materials, and other types of fibers. Its utility can be utilized in various industries including textile, construction, electronics, arts and crafts, and much more. The easy-to-use, efficient, and versatile features of this invention present a significant improvement in the handling, storage, and manipulation of fibers while avoiding tangling, damage or wastage, thus increasing productivity and preserving material quality.

The tray includes a spool, which is composed of a cylindrical hub core providing the central part where the fiber is wrapped. The spool's design ensures a consistent winding layout, minimizing tangling and overlapping, consequently improving the handling process during operation, storage, and shipment. The cylindrical hub core is strategically engineered to accommodate a wide range of fiber types and sizes. Its cylindrical shape not only maximizes the surface area available for winding but also aids in maintaining the fiber's inherent physical properties by preventing unnecessary pressure that could lead to structural breaks or deformation. The hub core allows the fiber to maintain its original form when coiled around it, thereby preventing potential signal loss (in case of optical fibers) or compromised material strength (in the case of textile fibers). The design of the hub core is conducive for accommodating a range of loads, making it versatile for various industrial applications.

Moreover, the tray's construction is robust and user-friendly, designed with careful consideration of various practical aspects such as secure loading, easy unloading, and efficient spool rotation. The tray, equipped with the spool and cylindrical hub core, not only provides an effective solution for fiber storage but also contributes to reducing operational downtime by ensuring quick fiber accessibility and seamless setup, which are crucial for increasing productivity in relevant industries. The embodiment of the tray inclusive of the spool and the hub core aligns with the real-world requirements of speed, safety, and efficiency, making it a pragmatic invention with significant industrial utility. The device of claim 1, by virtue of its design and functionalities, presents a novel, efficient, and practical way of managing and conserving fiber.

The opto-electronic module can serve as an active component, capable of transmitting or receiving optical signals through an optical fiber. In this context, the role of the novel guide is to provide a structured path for the optical fiber, preventing it from exceeding a pre-determined bend radius, thereby reducing potential risks associated with signal loss or fiber damage. The guide that can be made from materials possessing high rigidity to securely maintain the fiber's path, such as metal, plastic or composite materials. By facilitating a safe and sound conduit for the optical fiber, the novel guide significantly improves the reliability and performance of the opto-electronic module.

The guide's utility becomes more apparent when considering the delicate nature of optical fibers, known for their remarkable capacity to transmit data at high speeds but susceptible to signal loss when bent or coiled excessively. Such signal loss, often referred to as bend loss, usually occurs when the bend radius of an optical fiber falls below a critical value. Since the efficiency of the optical signal is of utmost importance, it is desirable to manage the bend radius of the fiber meticulously. Hence, the guide with its provision to maintain a pre-determined bend radius impeccably solves this conundrum of maintaining the delicate balance between bend radius and signal loss.

Additionally, the guide extends from the opto-electronic module, providing an integrated and robust solution suitable for various applications, ranging from telecommunication to data centers. The extension of the guide bolsters its flexibility, letting it adapt to different scenarios that may require varying lengths of optical fiber. Furthermore, it simplifies the module assembly process, minimizing the need for meticulous manual fiber routing, thereby saving a significant amount of installation time. Altogether, this patent manifests a novel solution that utilizes a specially designed guide to extend from an opto-electronics module to guard an optical fiber from excessive bending, thus boosting signal integrity, module reliability, and ease of installation.

The guide provides a predetermined bend radius to the optical fiber before it gets mounted on the winding tray. In its simplest form, the device may be construed as a physical guide, typically constructed of durable material, that can be adjusted according to the required bending radius. The guide would create a specific path to permit the optical fiber to follow and adapt its shape, thus, ensuring a uniformity in the curvature of the fiber and eliminating any possibility of data loss due to inconsistent bending. The physical design of the guide, such as its diameter and leading edge design, ensures that the optical fiber is gently bent without experiencing any mechanical stress that could potentially damage the fiber.

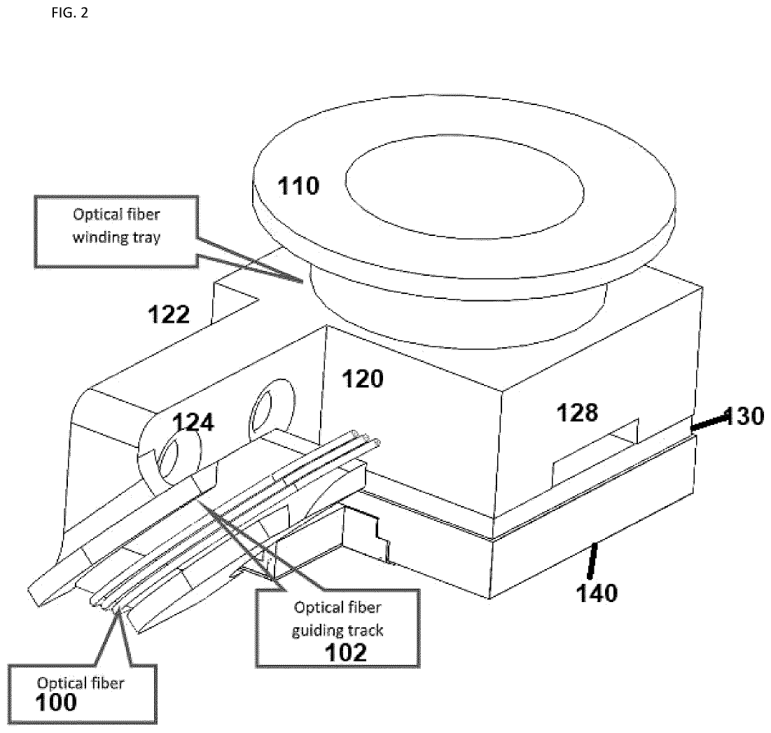

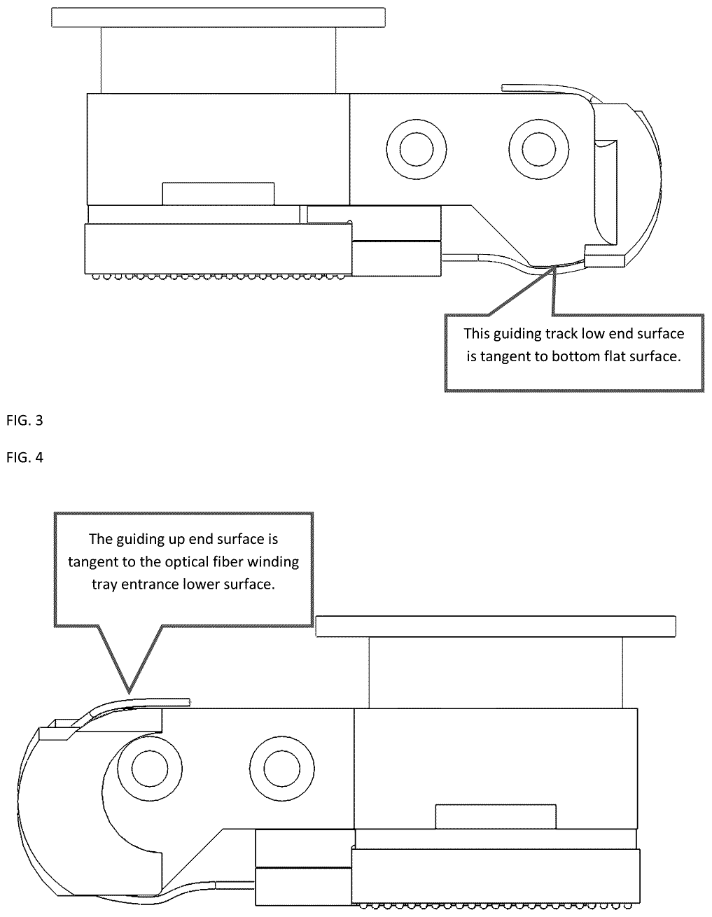

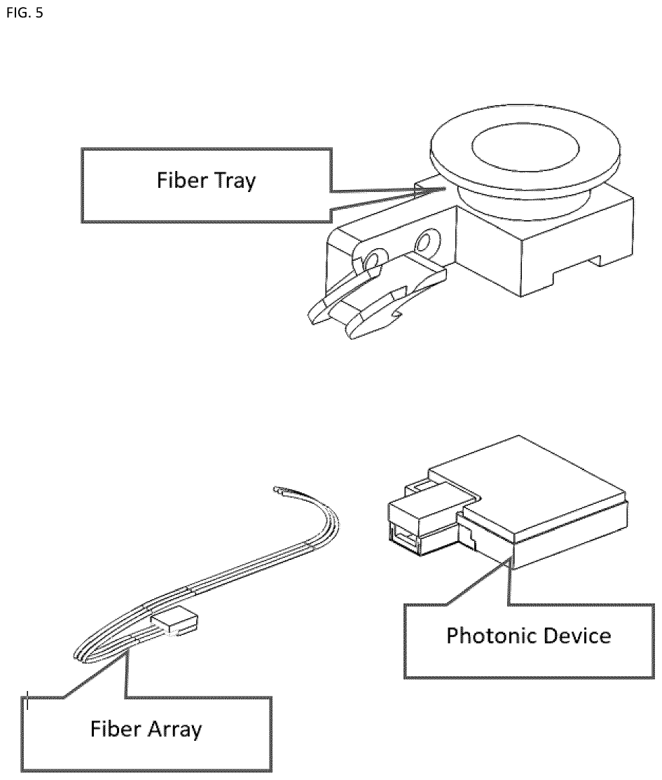

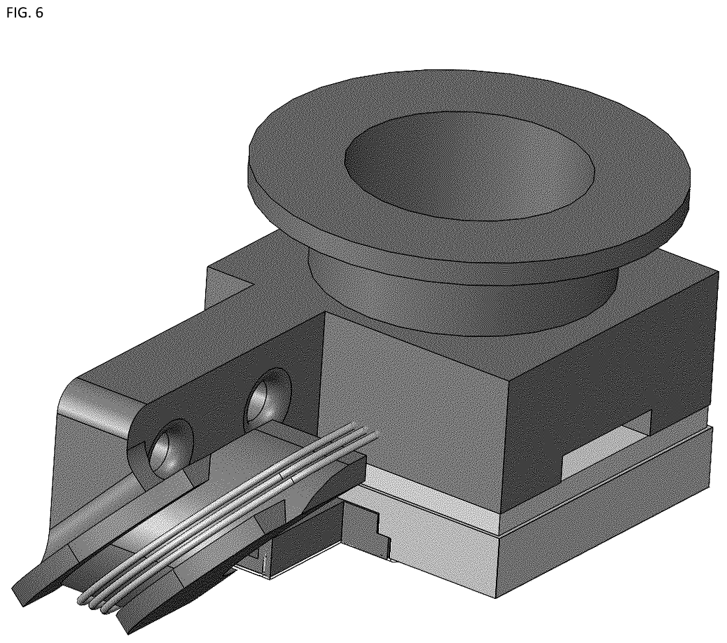

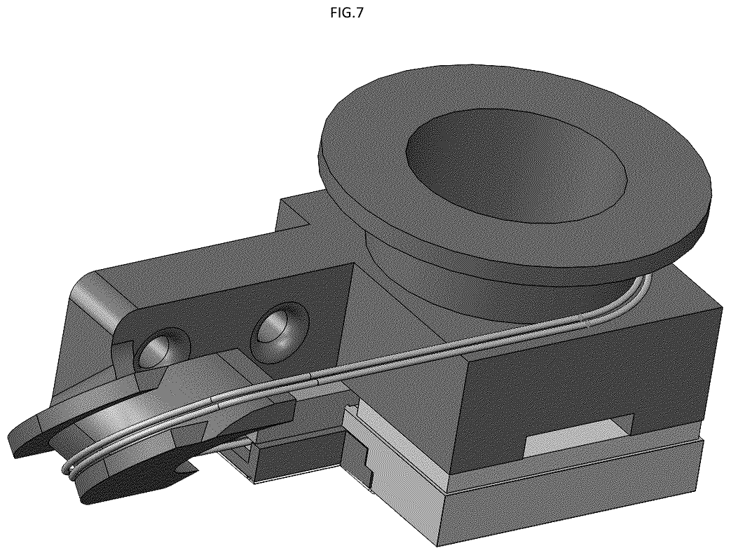

With the idea of further enhancing the operational efficiency and durability of optical fibers, the device of FIG. 2 offers a robust solution that can be seamlessly integrated into the present fiber optic installation processes. As a preventive mechanism, it considerably reduces the risk of faulty installations, signal interference, or fiber damage during the winding process. This not only increases the functional life of the optical fiber but also reduces maintenance and replacement costs associated with optical cable infrastructure. Moreover, the ease and simplicity of the patented device's operation can significantly speed up the installation process of fiber-optics, potentially leading to significant operational efficiencies and cost savings in the long run. It creates a smooth, undeviating path for the optical fiber to follow, allowing even untrained personnel to mount the fiber optic cables quickly and correctly, facilitating versatile applications across diverse fields.

Turning now to FIG. 2, the device includes an optical fiber winding tray 110 positioned above a U-shaped frame or module 120 with opening 128. The module 120 has a mounting arm 122 with openings 124. The module 120 is positioned above an opto-electronic device with two portions 130 and 140. The opto-electronic device has one or more optical fibers 100 extending from one end that is spooled on the winding tray 110. However, if the fiber 100 is directly wound onto the tray 110, the fiber 100 may be damaged if the minimum bend radius is not complied with. To address this problem, an optical fiber guide 102 with an angled track extends from the bottom of the device bottom portion 140 and provides the fiber 100 with the minimum bend radius before it is spooled by the winding tray 110.

The design provides a small footprint fiber tray over the optical module which still have all the fiber bending curvature larger than 5 mm so that a low cost 5 mm bending radium fiber can be used without causing fiber damage. The design achieves the all the bending curvature larger than 5 mm while maintaining small footprint. The design can provide a) meet large than 5 mm bending radius in the design for both protection the fiber and also allow to us of low cost fiber with 5 mm bending radius rather than expensive fiber with an even smaller bending radius requirement.

The guide exhibits an angled guide surface. The angled guide surface features an integrated design that promotes relaxed, unimpeded and controlled directional maneuvering. This unique configuration helps to streamline fiber movement process, providing superior navigation capabilities to the end-users of the device. The angled guide surface contributes to the maximization of the efficiency and effectiveness of the device movement.

A guide apparatus is provided having guide rails on either side of the guide. These guide rails act as a vital component to maintain a stable and straight path of motion for the objects or machinery using this guide. The device is engineered with great precision, ensuring the guide rails are placed symmetrically on both sides of the guide, enabling it to provide a balanced trajectory. The rails facilitate the smooth slip, slide, or roll of different objects or modules, ensuring controlled and guided movement. They are designed to handle varying loads and speeds without compromising the performance and durability of the guide.

The guide rails can be made of an assortment of materials such as metal, plastic, or even hardened glass, depending upon the degree of strength, resistance, durability required and the type of application. For heavy-duty applications, resilient materials like stainless steel or hardened alloys are utilized. The guide rails are also designed considering different environmental conditions. They can be electropolished, acid-resistant, or corrosion-resistant to withstand harsh environmental circumstances. The guide rails can be adapted according to the specific design requirements of the guide. The invention warrants a meticulous structural arrangement where these guide rails are determinedly affixed to each side of the guide.

This enhanced guide device's principal use can be seen in a wide array of settings including, but not limited to, machinery alignment, materials handling, transportation systems, and various types of sliding or rolling mechanisms. The guide rails device is oriented towards providing an efficient guide system that serves to eliminate alignment-related issues, reduce friction, minimize wear and tear, and thereby increase the overall lifespan and performance of the machinery or system that utilizes this invention. The unique architecture of the device ensures a significant improvement in safety, reliability, and operational effectiveness in various industrial and mechanical applications.

The guide also incorporates a unique V-shaped guide surface that allows the fiber to collect at the bottom of the V-shaped surface. The guide in the apparatus forms the central core of the innovation and significantly improves the overall operation and functionality of the system. The guide with the V-shaped guide surface is particularly conceived to direct and control the motion of objects or materials through the device. The V-shape provides the advantage of facilitating a smooth and unobstructed passage of these components. This configuration aims to minimize friction, promote efficient flow, and reduce wear and tear on both the moving constituents and the guide itself. Furthermore, the V-shaped guide surface presents an optimal angle, wherein the object or materials can slide or roll along the surface easily.

The opto-electronic module can include an integrated waveguide and a solid-state laser. The laser can modulate and direct the propagation of light to enhance precision, speed, and efficiency in various applications including, but not limited to, spectroscopy, laser printing, fiber optic communication, and medical devices. The componentry of this module is designed in such a manner so as to convert an electrical signal into a light signal and subsequently transmit it, within an integrated, compact, and controlled system.

In its broadest configuration, the module includes a solid-state laser that acts as the primary source of light. The choice of solid-state lasers allows for consistent generation of high-density light with controllable permutations of wavelength and frequency. Furthermore, it proves to be invaluable in terms of extending the module's operational life and minimizing the necessity for frequent maintenance. Adjacent to the solid-state laser is a waveguide that acts as a conduit for the propagation of this light. The waveguide operates on the principle of total internal reflection, efficiently channeling the laser light through refractive index differential without considerable loss of power. Notably, the waveguide also serves to shape the light beam, ensuring it is of optimal form for the next stage of transmission or application.

The waveguide-laser combination can be adeptly calibrated to project light of a specific wavelength, optimizing the output for a given application. This allows for a diverse array of possible uses, ranging from producing the precise minuscule light spots required in laser printers, to generating the high-energy pulses necessary for medical procedures. Perhaps the most significant advantage of this invention lies in its potential for miniaturization and integration. Given the compact nature of both the solid-state laser and the waveguide, the opto-electronic module facilitates the reduction of overall device size. This is favorable for technologies that require compact, efficient, and precise light-producing modules, such as handheld optical devices and communication systems. All these facets contribute to the potential of this invention to revolutionize the field of light-based technologies.

The subject invention pertains to a thermal management tool integrated into a device, more specifically, a heat sink connected to the bottom surface module of the device. The heat sink operates with the aim of diminishing the intensity of heat produced by the device during use. Ensuring efficient heat dispersion is critical for maintaining and prolonging the life and operational efficiency of the device. The design and configuration of the heat sink offer an optimized solution for thermal management by allowing faster and more efficient heat transfer away from the device and into the surrounding environment. The heat sink utilized in this invention is engineered with a set of materials characterized by high thermal conductivity, such as copper or aluminum alloys. The heat sink is coupled to the module bottom surface, where it serves to absorb the generated heat and dissipate it efficiently. This coupling system may apply various techniques to enhance heat conductivity and ensure efficient cooling, such as thermal conductive adhesive, soldering, or mechanical fastening techniques.

In the broader context of the device, this heat sink contributes significantly to its overall operational efficiency and durability. The effect of overheating on electronic components is a well-established dilemma, leading to sub-optimal performance, accelerated wear and tear, and a greater chance of failure. By adding this heat sink to the module bottom surface, the device effectively mitigates these risks, ensuring a reliable and improved performance over time. This represents a substantial advancement in the domain of thermal management in electronic devices, directly addressing evolving user demands for improved device longevity and enhanced user experience.

The optical fiber winding tray is used to receive the optical fiber, together with a unique guide system, ensuring secure, smooth, and orderly delivery of the optical fiber from the opto-electronic module to the optical fiber winding tray. The guide comprises a feature that includes a track that helps in threading the optical fiber from the opto-electronic module to the optical fiber winding tray, which suggests an improved method of securing the optical fiber and significantly lessening the potential for damage.

The guide has a guide bottom surface that is tangent to the module bottom surface, and a guide top surface that is tangent to the tray bottom surface, offering a seamless interaction between the apparatus components. This configuration not only ensures efficient transmission of the optical fiber but also prevents potential friction or obstruction that may arise if there's a misalignment in the parts. Once the optical fiber has been rightfully threaded through the track on the guide and reached the winding tray, this tray spool is rotated to take up the optical fiber. This action allows for the efficient and neat collection of the optical fiber onto the tray. It also secures the optical fiber from damage or wastage as it ensures organized coiling.

The system envisages a cost-effective solution to managing and handling optical fibers more conveniently. As it alleviates potential damages that can arise from the current practice of haphazardly organizing optical fibers after it is coupled to an opto-electronic module, cost-saving is substantial in the long run as the need for regular replacement of damaged or wasted pieces can be eliminated.

The method ensures that the setup process is not only effective in securing the optical fiber but can also enhance its overall performance. This invention satisfies the prerequisites of efficiency and effectiveness, which are crucial in the management and operation of the opto-electronic modules and associated optical fibers. On the whole, this invention offers an improved, cost-effective, and approachable solution for securing an optical fiber coupled to an opto-electronic module, promising reliable and resilient utility.

The present invention relates to a unique and utilitarian design which fundamentally comprises a tray system inclusive of a spool and is characterized by a fiber element wound around a cylindrical hub core. While optical fiber is detailed above, the inventive device serves a plethora of applications within various industries, with the core utilization being in efficient storage and transport of fibers such as yarns, threads, wires, ropes, or any other elongated flexible body, which entails a unique wrapping and unwrapping system. This invention is devised with the intent to enhance efficiency, promote organized storage, and simplify usage for the end users.

The tray, as described, integrates a spool, laid out such that it can facilitate the winding and unwinding of the fiber. The spool is fashioned in a way that it allows the fiber to be seamlessly wrapped around, protecting it from tangling, knotting, and other potential damages. The cylindrical hub core facilitates smooth rotation and provides structural stability to the spool, enabling the user to efficiently manage the fiber. The cylindrical hub can be made from various materials, including but not limited to plastic, metal, or wood, depending on its intended application and user requirements. The cylindrical structure enhances the ease with which the fiber can be wound and unwound, hence promoting efficient utilization of the fiber.

The tray, along with the spool and fiber, can be customized to cater to varying user preferences and requirements. The diameter of the spool, the thickness of the hub, and the type and length of the fiber, everything can be modified in accordance with the specific use-case scenario, without deviating from the primary function of the invention, which is organizing and storing the fiber. This makes the invention a versatile commodity, catering to a wide range of applications, from industrial setups to household uses, providing ease and efficiency in all spectrums.

The opto-electronic module, functioning as the chief component, accommodates various functionalities including but not limited to converting different types of signals, data management, and transmission. The module is designed in such a manner that it significantly reduces potential damage that could be caused to the optical fibers due to excessive bending, twisting, or other forms of mishandling. This is made possible through the integration of a uniquely engineered guide that extends from the opto-electronic module.

This guide serves a dual function of protection and control by providing a predetermined bend radius for the optical fiber. The construction of the guide is of an innovative design that permits a particular level of flexibility but at the same time maintains the integrity of the bend radius. Thereby it serves to mitigate potential strain on the fiber while assisting with the efficient signal transmission. The guide's fusion with the opto-electronic module provides an optimized safety measure to the vulnerabilities that optical fibers may experience. It helps to enhance the lifespan of the optical fiber while ensuring that the optimal level of signal quality is maintained consistently.

The opto-electronic module and guide combination is meticulously designed to allow easy installation, rehabilitation, or replacement of optical fibers without causing any major disruption to the operative system. The unique design of the guide ensures that even under circumstances where extreme bends need to be executed, the potentiality of microbends, macrobends, or fiber fractures instigated by undue stress is significantly reduced. The module's robust design combined with the protective guide performs to ensure the optical fiber's longevity and efficiency, thereby overall accentuating the productivity of opto-electronic systems.

The present design pertains to a method for managing and securing an optical fiber, particularly in a situation where the fiber is to be wound on a tray. The invention comprises providing a predetermined bend radius for the optical fiber prior to mounting it onto the winding tray. A designated bend radius is critical in installation settings—an improper or varying bend radius can lead to defects in transmission of data or even physical damage to the fiber itself. This design ensures consistency and uniformity in the wrapping of the fiber thereby preventing any possible ensuing damage.

The first step involves calculating the appropriate bend radius based on the specifications of the optical fiber. The bend radius is an essential aspect in fiber management—it refers to the minimum radius a fiber optic cable can bend without kinking, damaging, or experiencing significant signal loss. The bending radius should never go beyond the capacity of the fiber; doing so would cause excessive stress on the fiber, impair its integrity and lead to eventual failure. After determining the predetermined bend radius, the method then implicates providing a mechanical guide to help install the fiber onto the winding tray with the set bend radius.

The winding tray in this invention is specialized for mounting the optical fiber smoothly without causing any damage. It also contributes to maintaining the determined bend radius during the winding process. The tray is designed such that it allows for easy adjustments to suit different kinds of fibers and bend radii. Once the optical fiber has been correctly oriented and secured on the winding tray at the pre-determined bend radius, the fiber can then be safely packaged, transported and later installed at its final destination. Ultimately, this method provides an efficient and effective way to manage and secure optical fiber, ensuring its safety and maintenance of quality signal transmission.

The system provides an effective and precise means of positioning optical fibers with reduced risks of damage and increased operating efficiency. This method involves threading the optical fiber onto the angled guide surface, an inventive approach that allows for safe and effective handling of these delicate components. By integrating angling into the guide surface, the invention uniquely utilizes geometric principles to facilitate the threading process, making it more efficient and reliable.

The angled guide surface serves to efficiently direct the path of the optical fiber as it's being threaded. The acute angle of the guide surface, relative to the optical fiber, enables the user to accurately position the fiber for optimized threadability. This innovative technique not only speeds up the process but also considerably reduces the potential for error or damage to the fiber that might otherwise occur during the threading process. The use of this method is versatile and can be applied in a range of settings, from data centres to telecommunication installations where the secure threading and robust handling of optical fibers are critically important.

The method offers a safe technique that can ensure the longevity and effectiveness of the optical fibers. Due to the fine and delicate nature of working with optical fibers, any potential threat, including improper positioning or handling, can result in severe damages to the fibers, subsequently compromising their performance or effectiveness. However, by using this invention's method, users can reduce these risks considerably. Beyond ensuring the functionality of the optical fibers, this method also enhances work efficiency and overall productivity, proving its worth as an integral strategy in the modern handling of optical fibers. The application of an angled guide surface for threading optical fibers is an innovative approach sure to streamline operations in a variety of industries reliant on these essential components. The provision of guide rails on either side of the guide can facilitate navigation and control within a designated path. This innovative system utilizes the principle of confinement and sliding action within parallel guide rails to maintain and direct an object or user along a predetermined trajectory. With the guide rails in operation on either side, this system introduces a significant reduction in errors often associated with freehand or manual steering. The guide rails provide a reliable mechanism for guiding the movement of an object or person along a controlled path thereby minimizing risks of veering off course, leading to improved consistency and accuracy of movement. Users can align the rails, extend or decrease the lengths, or even vary the shape to match the terrain or space as per the requirements. The guide rails are detachable and may also be equipped with attributes such as extension capabilities and rotatable joints, making it possible to manipulate their configuration and offering customization options. Consequently, the invention simplifies operational handling, enhances safety, reduces labor and resource expenditure, and bolsters efficiency. It is therefore envisaged to bring tremendous value to industries and sectors where control in navigation or movement is paramount.

The V-shaped guide surface serves to carefully and accurately guide the optical fiber along its necessary path without causing any damage. The V-shaped design ensures that the optical fiber is held securely, minimizing the risk of slipping or misalignment and thereby reducing the likelihood of errors or damage during operation. By using this V-shaped guide surface, the handling of optical fibers becomes notably more straightforward and safe, enabling efficient work, even under challenging conditions. The guide surface can be fabricated from a variety of materials with properties tailored specifically to the requirements of different applications. The threading process is precise yet gentle, designed to protect the integrity of the fiber while ensuring the accurate alignment necessary for optimal performance. By integrating these steps into the threading process, the invention provides an effective means to secure, protect, and manipulate optical fibers during installation, operation, and maintenance. This innovative method can potentially expedite the process of working with optical fibers while minimizing the risk of failures, thus enhancing overall productivity and efficiency.

The innovative method of securing the optical fiber during the communication of light from a waveguide and a solid-state laser enables the widespread use of electromagnetic waves, and particularly optical waves, in telecommunication. It aims at enhancing the utilization of these technologies by using optical communications via waveguides and solid-state lasers. The design of the invention places its core operation within the hybrid realm of scientific advancement and technology, effectively harnessing the benefits of combining waveguides and solid-state lasers in a unique manner to achieve controlled and efficient communication of light.

In one embodiment, the waveguide directs the light to a specific path. It narrows the light's scattering, thus permitting the communication of high-density data without significant loss. The size and structure of the waveguide can be altered per specific requirements, providing flexibility of usage in diverse applications. On the other hand, the role of solid-state lasers is significant in the provision of the light source. As the primary source of light, the solid-state laser is chosen for its high stability, longevity, and ability to produce highly coherent light. The solid-state laser generates light that is subsequently directed into the waveguide, allowing for a practically lossless communication path and consequently higher data integrity.

Further advantages pertaining to the aforementioned method are numerous, depending on the application in which it is being utilized. The implementation and functionality of this method in the telecommunication sector, medical field, and data transmission system, among others, yield a significant advantage. The integration of waveguides and solid-state lasers promises a novel system that enhances stability, reduces the size and weight of devices, and offers superior operation speed and data transfer rate. Moreover, it allows the energy to be concentrated in a specific direction and space, increasing efficiency and minimizing energy waste. This inventive technology holds the potential to revolutionize the optical communication field and beyond by providing a high speed, robust and efficient system for light communication.

The tray is compatible with optical device operation that involves the removal of heat from the bottom surface of a given optical device or module. The generation of excessive heat within various systems and modules can hinder the efficiency of several devices and systems, particularly those involved in electrical, mechanical, and processing operations. When an excess amount of heat is generated in a system, it frequently requires increased energy utilization to maintain operations within acceptable operating parameters, thereby adversely impacting the energy efficiency of such systems. In one embodiment, the winding tray can be thermally conductive and thus provides a strategic mechanism that is decidedly focused on redirecting heat away from the bottom surface of the module. The optimal removal of heat would ensure that the system maintains a balanced thermal environment, thereby making it more energy-efficient and consistent in its operations. By removing the heat from the module bottom surface, it can facilitate a decrease in the overall temperature. It prevents the system from reaching levels of heat that could potentially damage or disrupt the operations of the module or corresponding system.

An electronic module with a waveguide and solid state laser can be used to send beams through an optical fiber that is wound on a tray. The waveguide will guide the light from the laser into the optical fiber, which can then be routed through the winding tray. The tray provides protection to the fiber from mechanical damage while it is being handled or installed. Additionally, the tray ensures that the optical fibers are correctly aligned and connected to the appropriate components in the system. This module could be used for a variety of applications such as communication systems, medical imaging systems, sensing systems, and optical data storage systems.

In another embodiment, the winding tray can be modified to become a fiber optic coil winding for gyroscopes. The guide and tray can precisely control the pitch angle, pre-tension, post-tension, and wrap angle to meet the required accuracy. In this embodiment, an auto-tracking system monitors the position of the fiber and the speed at which it is wound, and automatically adjusts its parameters accordingly. The winding program can be customized according to the requirement of customer, and the performance data can be saved for future reference. The main advantages of this equipment are high efficiency, reliable operation, low noise, and cost savings.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method to secure an optical fiber with a minimum bend radius coupled to an opto-electronic module having a module bottom surface, the method comprising:
providing an optical fiber winding tray to receive the optical fiber, the optical fiber winding tray having a footprint smaller than the module bottom surface;
coupling a guide to the opto-electronic module and the optical fiber winding tray, the guide extending from the module bottom surface and receiving the optical fiber thereon, wherein the guide provides an optical fiber bending curvature greater than the minimum bend radius; and
rotating the optical fiber winding tray to spool the optical fiber on the guide onto the optical fiber winding tray.

2. The method of claim 1, wherein the tray, comprises a spool and the fiber is wound around a cylindrical hub core.

3. The method of claim 1, wherein the guide provides a fiber bending curvature larger than about five millimeters (5 mm).

4. The method of claim 1, comprising providing a predetermined bend radius for the optical fiber prior to mounting on the winding tray.

5. The method of claim 1, comprising threading the optical fiber on an angled guide surface.

6. The method of claim 1, comprising providing guide rails on either side of the guide.

7. The method of claim 1, comprising threading the optical fiber on a V-shaped guide surface.

8. The method of claim 1, comprising communicating light from a waveguide and a solid-state laser.

9. The method of claim 1, comprising removing heat from the module bottom surface.

10. A method to secure an optical fiber coupled to a silicon photonic or an opto-electronic module having a module bottom surface, the method comprising:
providing an optical fiber winding tray to receive the optical fiber, the optical fiber winding tray having a tray bottom surface;
coupling a guide to the opto-electronic module and the optical fiber winding tray, the guide including a track to thread the optical fiber from the opto-electronic module to the optical fiber winding tray, wherein the guide comprises a guide bottom surface tangent to the module bottom surface and a guide top surface tangent to the tray bottom surface; and
rotating the optical fiber winding tray to spool the optical fiber onto the optical fiber winding tray.

11. A device, comprising:
a silicon photonic module or an opto-electronic module including an optical fiber and a module bottom surface;
an optical fiber winding tray to receive the optical fiber, the optical fiber winding tray having a tray bottom surface; and
a guide coupled to the opto-electronic module and the optical fiber winding tray, the guide including a track to thread the optical fiber from the silicon photonic or opto-electronic module to the optical fiber winding tray, wherein the guide extends from the module bottom surface towards the optical fiber winding tray to provide an optical fiber bending curvature greater than the minimum bend radius.

12. The device of claim 11, wherein the guide comprises a V-shaped guide surface.

13. The device of claim 11, wherein the opto-electronic module comprises a waveguide and a solid-state laser.

14. The device of claim 11, comprising a heat sink coupled to the module bottom surface.

15. The device of claim 11, wherein the tray is rotated to wound the fibers on the tray.

16. The device of claim 11, wherein the tray comprises a spool and the fiber is wound around a cylindrical hub core.

17. The device of claim 11, wherein the guide extends from the opto-electronic module and provide a predetermined bend radius for the optical fiber.

18. The device of claim 11, wherein the guide comprises an angled guide surface.

19. The device of claim 11, wherein the guide comprises guide rails on either side of the guide.

20. The device of claim 11, wherein the guide comprises a guide bottom surface tangent to the module bottom surface and a guide top surface tangent to the tray bottom surface.
